(19) United States
(12) Patent Application Publication
(10) Pub. No.: US 2020/0139271 A1
(43) Pub. Date: May 7, 2020

(54) Two Stage Elements

(71) Applicant: Schroeder Industries, LLC, Leetsdale, PA (US)

(72) Inventors: Michael J. Schmitt, Pittsburgh, PA (US); Christopher B. Bortnik, Warrendale, PA (US); Scott F. Surdick, Dormont, PA (US); Thomas Ryan-Lorei, Erie, PA (US)

(21) Appl. No.: 16/674,967

(22) Filed: Nov. 5, 2019

Related U.S. Application Data
(60) Provisional application No. 62/756,035, filed on Nov. 5, 2018.

(51) Int. Cl. B01D 29/58; B01D 29/15; B01D 29/23

(52) U.S. Cl. CPC B01D 29/58; B01D 29/15; B01D 2201/301; B01D 2201/298; B01D 29/23

(57) ABSTRACT

A drop-in filter element assembly with axial staged treatment includes a proximal endcap configured to be positioned within a filter housing adjacent the inlet flow through the filter element, first filter media extending from the proximal endcap and configured to treat the fluid flowing therethrough, an intermediate endcap unit coupled to the first filter media and spaced from the proximal endcap, second filter media extending from the intermediate endcap unit and configured to treat the fluid flowing therethrough, wherein the second filter media is a distinct type of media from the first filter media, and a distal endcap configured to be positioned within the filter housing adjacent the outlet flow through the filter element and coupled to the second filter media and spaced from the intermediate endcap unit, wherein the first and second filter media provide axially staged treatment to the fluid.

This application claims priority to U.S. patent application Ser. No. 62/756,035 filed Nov. 5, 2018, entitled “Two Stage Elements” which application is incorporated herein by reference in its entirety.

### BACKGROUND INFORMATION

### 1. Field of the Invention

The present invention relates to filter assemblies, and more particular the inventors Michael J. Schmidtt, Christopher B. Bortnik, Scott F. Surdick and Thomas Ryan-Lorei have developments related to drop-in filter element assemblies with axial staged treatment.

### 2. Background Information

The concept of staged filtration is generally known in various fields, for example U.S. Pat. No. 4,434,053, teaches a filter in an injection molding device in which in a first stage, coarse filtration is achieved by flow through the holes radially outwardly from the inlet passage into each of the filter grooves and a second stage, fine filtration occurs by flow from the filter grooves through circumferential clearance spaces located between each of several lands separating the filter grooves and the interior of the filter cavity.

U.S. Pat. No. 4,097,216 discloses an injection nozzle for an injection molding machine wherein the nozzle includes a body having a filter chamber and a filter element removably received in the chamber in the filter body. The outer surface of the filter element is defined by a plurality of slots which extend generally longitudinally of the element in circumferentially spaced positions, and a corresponding plurality of intervening lands. Each slot has a blind inner end and an outer end which opens into an end of the filter element, the slots being arranged so that alternate slots communicate by way of their outer ends with the filter chamber inlet opening and define with the inner surface of the filter chamber, inlet flow channels for liquid to be filtered, while the intervening slots communicate with the filter chamber outlet opening and similarly define outlet flow channels for said liquid. The lands between the slots define filtering gaps which provide liquid communication between adjacent flow channels and are dimensioned to prevent particles above a predetermined size passing through the filter element.

U.S. Pat. No. 3,767,056 discloses filtering device for use in high pressure injection molding apparatus. The filter consists of a housing having a material flow inlet and outlet, the housing having a longitudinal bore which communicates with the inlet and outlet. A cylindrical member having a plurality of radially disposed filtration openings is positioned in the longitudinal bore to define first and second concentrically disposed flow passages. A valve member comprising a tapered pin with a transverse bore registerable with the first passage is rotatable to either block the first passage and thereby effect filtering flow through the radially disposed holes and second passage, or to permit a purge flow through the essentially unrestricted first passage.

U.S. Pat. No. 4,906,360 discloses a multi-stage filter for filtering injection molding melt includes an elongate filter element having a filter inlet end, a filter outlet end and a plurality of filter stages axially disposed on the element and adjoining each other. Each filter stage includes a plurality of axial filter grooves in its outer surface which are spaced apart from a filter chamber wall to define a distinct filter clearance for each filter stage. The axial filter grooves are circumferentially spaced apart from each other and alternate with axial grooves axially extending between adjoining filter stages which define melt transfer passages to transfer melt between filter stages.

Outside of the injection molding field, staged filtration for drop-in type filters has typically been utilized with distinct separate drop in filter elements arranged in series. This can be effective where space is not a concern, however many applications have minimal space requirements preventing the use of multiple filter housings in series.

There remains a need in the art for drop-in filter element assemblies with axial staged treatment.

### SUMMARY OF THE INVENTION

This invention is directed to a cost effective, efficient, drop-in filter element assemblies with axial staged treatment.

One aspect of the invention provides a drop-in filter element assembly with axial staged treatment comprising a proximal endcap configured to be positioned within a filter housing adjacent the inlet flow through the filter element, first filter media extending from the proximal endcap and configured to treat the fluid flowing therethrough, an intermediate endcap unit coupled to the first filter media and spaced from the proximal endcap, second filter media extending from the intermediate endcap unit and configured to treat the fluid flowing therethrough, wherein the second filter media is a distinct media from the first filter media, and a distal endcap configured to be positioned within the filter housing adjacent the outlet flow through the filter element and coupled to the second filter media and spaced from the intermediate endcap unit, wherein the first and second filter media provide axially staged treatment to the fluid.

These and other advantages of the present invention will be clarified in the following description taken together with the attached figures in which like reference numerals represent like elements throughout.

### BRIEF DESCRIPTION OF THE FIGURES

FIG. 1 is a side elevation view of a two staged outside-in/outside-in drop in filter element according one embodiment of the present invention;

FIG. 2 is a side elevation section view of the two staged filter element of FIG. 1;

FIG. 3 is an end view of a closed end cap for the two staged filter element of FIG. 1;

FIG. 4 is an end view of an open center end cap for the two staged filter element of FIG. 1;

FIG. 5 is a side elevation view of a two staged inside-out/inside-out drop in filter element according one embodiment of the present invention;

FIG. 6 is a side elevation section view of the two staged filter element of FIG. 5;

FIG. 7 is a side elevation view of a filter housing for a two staged outside-in/inside-out drop in filter element according one embodiment of the present invention;

FIG. 8 is a side elevation section view of the filter housing and the two staged outside-in/inside-out in drop in filter element of FIG. 7;

FIG. 9 is a side elevation view of a two staged inside-out/outside-in drop in filter element according one embodiment of the present invention;

FIG. 10 is a side elevation section view of the filter housing and the two staged Inside-out/outside-in drop in filter element of FIG. 9;

FIG. 11 is a perspective exploded view illustrating modular intermediate endcap attachment for a modified two staged outside-in/inside-out in drop in filter element of FIG. 7; and

FIG. 12 is a side elevation view illustrating the modular intermediate endcap attachment of FIG. 11.

### BRIEF DESCRIPTION OF THE PREFERRED EMBODIMENTS

The present invention is directed to a drop-in filter element assembly 10, 40, 60, 80 associated with a particular filter housing (such as 62) having an inlet at one end and an outlet at an opposite end thereof. The inlet is described as being on the proximal end while the outlet is on the distal end of the housing, and these are terms chosen respective to the direction of fluid flow as opposed to position relative to the observer or other positional landmarks. A drop-in filter element assembly 10, 40, 60, 80 may also be referenced as a replaceable filter element assembly. The present invention relates to a drop-in filter element assembly 10, 40, 60, 80 yielding axial staged fluid treatment, wherein the fluid receives a distinct treatment or conditioning at each of two stages of the drop-in filter element assembly 10, 40, 60, 80 of the present invention.

The drop-in filter element assembly 10, 40, 60, 80 includes a proximal endcap 12, 28, 72 configured to be positioned within a filter housing adjacent the housing inlet and inlet flow through the filter element assembly 10, 40, 60, 80. The proximal endcap (see 28) may seal with a seal 30 against the inlet in a conventional fashion with the presence of the seal 30 generally being dependent upon whether the first stage is inside-out or outside in (i.e. whether the fluid is introduced from the housing inlet to the inside or the outside of the first stage). The proximal endcap 12, 28 and 72 is generally a one-piece structure and may be injection molded, and with a separate sealing member 30 (O-rings, ring seals or the like) if one is required.

The drop-in filter element assembly 10, 40, 60, 80 includes a first filter media 14, 44, 64, 54 extending from the proximal endcap 12, 28, 72 and configured to treat the fluid flowing therethrough. The first filter media 14, 44, 64, 54 may be pleated media or any desired media for forming the first stage of the fluid treatment for the drop-in filter element assembly 10, 40, 60, 80 of the invention. The first filter media 14, 44, 64, 54 may be formed as composite media of distinct types and includes a protective outer wrap and/or inner supports 16, 46, 66, 56. The first filter media may be coupled to the proximal endcap 12, 28, 72 through adhesive such as epoxy.

The drop-in filter element assembly 10, 40, 60, 80 includes an intermediate endcap unit (18, 20), 68, 82, (86, 88) coupled to the first filter media 14, 44, 64, 54 and spaced from the proximal endcap 12, 28, 72. The coupling of the first filter media 14, 44, 64, 54 to the intermediate endcap (18, 20), 68, 82, (86, 88) can be substantially the same as the coupling between the first filter media 14, 44, 64, 54 and the proximal endcap 12, 28, 72. The structure of the intermediate endcap unit (18, 20), 68, 82, (86, 88) differs depending upon the desired flow through the drop-in filter element assembly 10, 40, 60, 80 as discussed in detail below. In general, the intermediate endcap unit may be formed as two endcaps (18, 20), (86, 88) of the first and second stage coupled together in a modular arrangement of the present invention, or as an endcap 68, 82 as discussed below.

The drop-in filter element assembly 10, 40, 60, 80 includes a second filter media 24, 54, 64, 14 extending from the intermediate endcap unit (18, 20), 68, 82, (86, 88) and configured to treat the fluid flowing therethrough, wherein the second filter media is a distinct type of media from the first filter media and provides for the fluid treatment in the second axial stage of the assembly 10, 40, 60, 80. The second filter media 24, 54, 64, 14, like the first filter media 14, 44, 64, 54 may be formed as composite media of distinct types and includes a protective outer wrap and/or inner supports 26, 56, 66, 26. The specifics of the second filter media 24, 54, 64, 14 are determined by the desired second treatment regime for the fluid. The coupling of the second filter media 24, 54, 64, 14 to the intermediate endcap unit (18, 20), 68, 82, (86, 88) can be substantially the same as the coupling between the first filter media 14, 44, 64, 54 and the proximal endcap 12, 28, 72 or the intermediate endcap unit (18, 20), 68, 82, (86, 88).

The drop-in filter element assembly 10, 40, 60, 80 includes a distal endcap 28, 12, 72 configured to be positioned within a filter housing adjacent the housing outlet and the outlet flow from the filter element assembly 10, 40, 60, 80. The distal endcap 28 may seal against the outlet with a seal 30 in a conventional fashion with the presence of the seal 30 being dependent upon whether the second stage flow is inside-out or outside-in (i.e. whether the fluid is passing in the second stage of the assembly 10, 40, 60, 80 radially inward or outward of the second filter media). The distal endcap 28, 12, 72 may be injection molded and is generally a one-piece structure with separate sealing member 30 (O-rings, ring seals or the like), if provided. As discussed above the first and second filter media provide axially staged first and second fluid treatments to the fluid.

There are four distinct embodiments of the two staged filter element assembly 10, 40, 60, 80 present invention which are shown and discussed below. They can be categorized by the relative flow in each stage of the assembly.

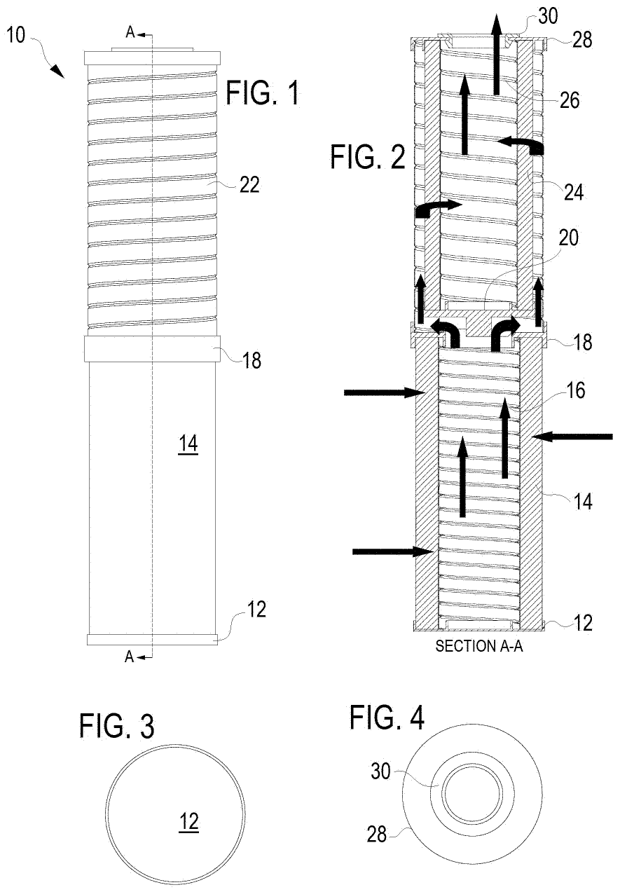

FIGS. 1-2 show a two staged outside-in/outside-in drop in filter element assembly 10 according one embodiment of the present invention. The two staged outside-in/outside-in drop in filter element assembly 10 has the flow from the housing inlet around the closed proximal endcap 12 to the exterior of the first filter media 14 of the first stage then through the first filter media 14 in a radial inward direction through the perforated support tube 16 to the interior of the first stage. From the interior of the first stage the partially treated fluid is then directed to the exterior of the second filter media 24 between the media 24 and a solid outer tube 22 through the intermediate endcap unit (18, 20). The intermediate end cap unit 18, 20 includes a first stage end cap 18 with open center and a closed center second stage end cap 20 that combine to define a radial passage(s) to the exterior of the second stage as shown. The two staged outside-in/outside-in drop in filter element assembly 10 has the flow in the second stage through the second filter media 24 in a radial inward direction through the perforated support tube 26 to the interior of the second stage. From the interior of the second stage the fully treated fluid is then directed to the outlet of the housing through the distal endcap 28 sealed to the outlet of the housing. The plan views of the proximal end cap 12 and the distal endcap 28 with seal 30 are shown in FIGS. 3 and 4, respectively.

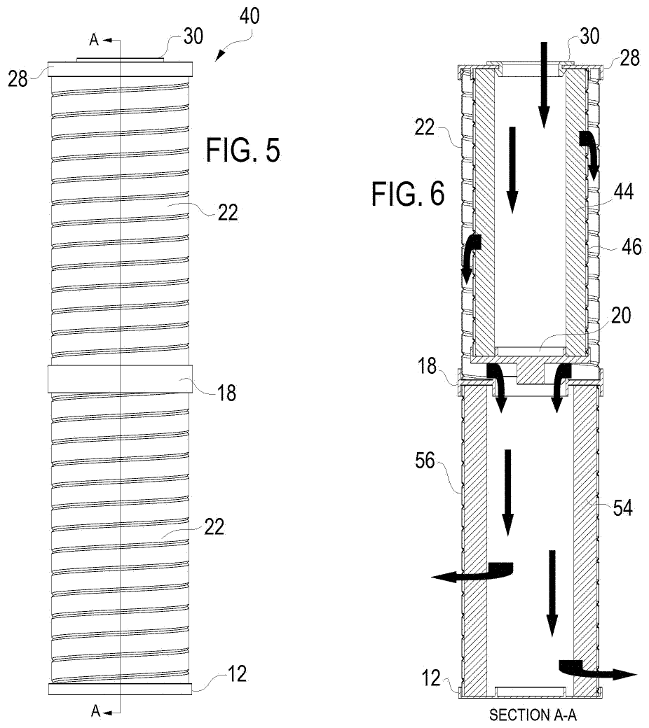

FIGS. 5-6 show a two staged inside-out/inside-out drop in filter element assembly 40 according one embodiment of the present invention. The inside-out/inside-out drop in filter element assembly 40 has the flow from the housing inlet through the open center proximal endcap 28 that is sealed to the inlet via seal 30 to the interior of the first filter media 44 of the first stage. From the interior of the first stage the fluid flows through the first filter media 44 in a radial outward direction through the perforated support tube 46 to the space between the tube 46 and the solid tube 22 of the first stage. The solid tube 22 is the same as found in assembly 10 of FIGS. 1-2. The open center proximal endcap 28 is the same as the distal endcap 28 of the assembly 10 of FIGS. 1-2. The filter media 44 is similar in position to the second stage media 24 of the assembly 10, except media 44 is designed for inside out flow as opposed to outside in flow.

From the annular exterior space of the first stage of the assembly 40 the partially treated fluid is then directed to the interior of the second filter media 54 through the intermediate endcap unit (18, 20). The intermediate end cap unit 18, 20 includes a second stage end cap 18 with open center and a closed center first stage end cap 20 that combine to define a radial passage(s) to the interior of the second stage as shown. The intermediate end cap unit (18, 20) is the same structure as the unit (18, 20) of the assembly 10, except that the endcap 18 is for the second stage and the endcap 20 is on the first stage. The two staged inside-out/inside-out drop in filter element assembly 40 has the flow in the second stage through the second filter media 54 in a radial outward direction through the media 54 and the perforated support tube 56 to the exterior of the second stage. From the exterior of the second stage the fully treated fluid is then directed to the outlet of the housing around the distal closed endcap 12 (which has the same structure as endcap 12 of assembly 10).

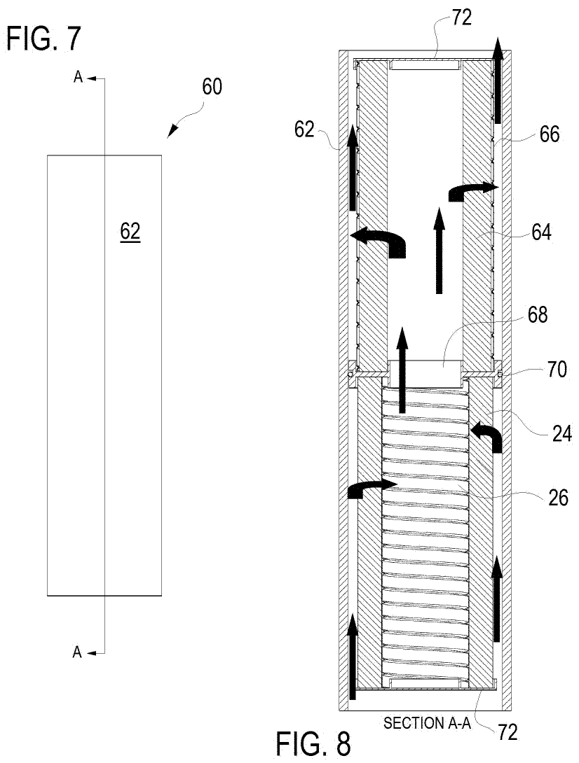

FIGS. 7-8 show a two staged outside-in/inside-out drop in filter element assembly 60 according one embodiment of the present invention. The outside-in/inside-out drop in filter element assembly 60 has the flow from the housing inlet around a closed center proximal endcap 72 to the exterior of the first filter media 24 of the first stage in an annular space between the media 24 and the wall of the filter element housing 62. From the exterior of the first stage the fluid flows through the first filter media 24 in a radial inward direction through the perforated support tube 26 to the interior of the first stage. The filter media 24 and support 26 has the same structure as the second stage of the assembly 10 discussed above.

From the interior space of the first stage of the assembly 60 the partially treated fluid is then directed to the interior of the second filter media 64 through the intermediate endcap unit 68. The intermediate end cap unit 68 includes a seal 70 engaging with the housing to isolate the annular pre-filter area of the first stage from the annular post filter area of the second stage.

The two staged outside-in/inside-out drop in filter element assembly 60 has the flow in the second stage through the second filter media 64 in a radial outward direction through the media 64 and the perforated support tube 66 to the exterior of the second stage in the post filter annular space. From the exterior of the second stage, the fully treated fluid is then directed to the outlet of the housing around the distal closed endcap 72, which has the same structure as proximal endcap 72 of assembly 60.

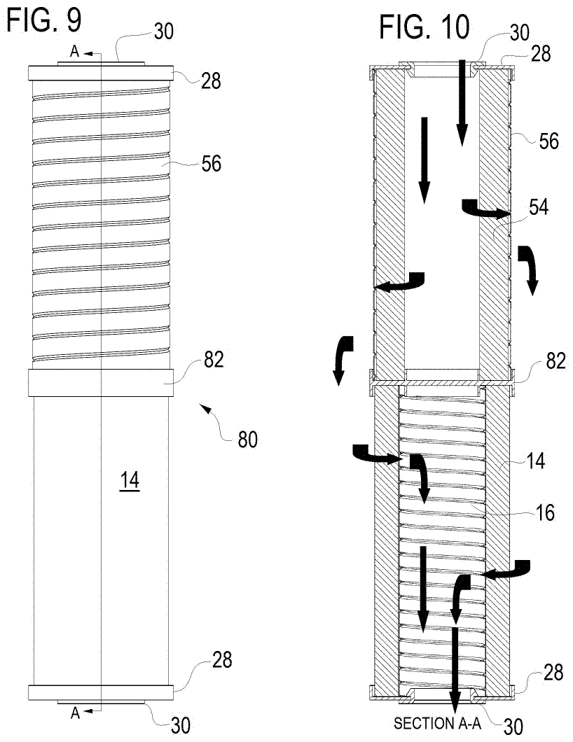

FIGS. 9-10 show a two staged inside-out/outside-in drop in filter element assembly 80 according one embodiment of the present invention. The inside-out/outside-in drop in filter element assembly 80 has the flow from the housing inlet through an open center proximal endcap 28 with seal 30. The proximal endcap 28 is the same as endcap 28 of assembly 40 discussed above. The flow in assembly 80 is to the interior of the first filter media 54 of the first stage. From the interior of the first stage the fluid flows through the first filter media 54 in a radial outward direction through the perforated support tube 56 to the exterior of the first stage. The filter media 54 and support 56 has the same structure as the second stage of the assembly 40 discussed above.

From the exterior space of the first stage of the assembly 80 the partially treated fluid is then directed to the exterior of the second filter media 14 around the closed center intermediate endcap unit 82.

The two staged drop in filter element assembly 80 has the flow in the second stage through the second filter media 14 in a radial inward direction through the media 14 and the perforated support tube 16 to the interior of the second stage. The structure of the second media 14 is the same as the first stage 14 of the assembly 10. From the interior of the second stage, the fully treated fluid is then directed to the outlet of the housing through the distal open center endcap 28 that seals to the outlet with seal 30.

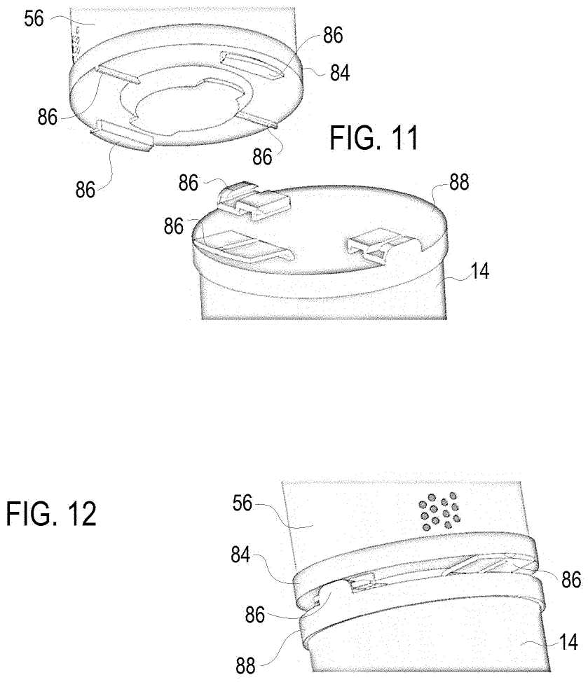

The Inside-out to Outside-in embodiment of assembly 80 also implements a “modular” concept forming the two stages as shown in FIGS. 11-12. The first stage would be inside to outside flow, and the second stages would be outside to inside flow as noted above. The two stages would be attached by coupling adjacent intermediate endcaps 84 and 88 with twist and lock coupling elements 86 that combine to form the intermediate endcap unit (84, 88) of the invention. The advantage of this modular design is the ability to easily pair two different stage types (Particulate removal/water removal; particulate removal/finer particulate removal, etc.).

It is envisioned that there would be a series of suitable first stages and a series of suitable second stages for a given housing and the stages coupled to form a desired staged treatment regime. The twist and lock arrangement may be formed on complementary intermediate cap portions forming the intermediate cap unit as schematically shown in FIGS. 11-12.

Not discussed or shown in the schematic representations above are the bypass valve arrangements to be implemented. One or Two bypass valves are needed for each assembly 10, 40, 60, 80. The details of the bypass(es) are not shown, but bypass configurations must be considered and implemented.

The preferred embodiments described above are illustrative of the present invention and not restrictive hereof. It will be obvious that various changes may be made to the present invention without departing from the spirit and scope of the invention. The precise scope of the present invention is defined by the appended claims and equivalents thereto.

What is claimed is:

1. A drop-in filter element assembly with axial staged treatment comprising:
a proximal endcap configured to be positioned within a filter housing adjacent the inlet flow through the filter element;
a first filter media extending from the proximal endcap and configured to treat the fluid flowing therethrough in a first stage;
an intermediate endcap unit coupled to the first filter media and spaced from the proximal endcap;
a second filter media extending from the intermediate endcap unit and configured to treat the fluid flowing therethrough in a second stage, wherein the second filter media is a distinct type of media from the first filter media; and
a distal endcap configured to be positioned within the filter housing adjacent the outlet flow through the filter element and coupled to the second filter media and spaced from the intermediate endcap unit, wherein the first and second filter media provide axially staged treatment to the fluid.

2. The drop-in filter element assembly according to claim 1 wherein the axial staged treatment is configured for outside-in flow in the first stage and outside-in flow in the second stage.

3. The drop-in filter element assembly according to claim 2 in which the intermediate endcap unit is configured to direct fluid from the interior of first filter media of the first stage to an exterior of second filter media of the second stage.

4. The drop-in filter element assembly according to claim 3 wherein the second stage includes a solid tube spaced from the second filter media forming an annular space receiving the partially treated fluid from the first stage.

5. The drop-in filter element assembly according to claim 1 wherein the axial staged treatment is configured for inside out flow in the first stage and outside-in flow in the second stage.

6. The drop-in filter element assembly according to claim 5 in which the intermediate endcap unit is configured to direct fluid from the exterior of first filter media of the first stage to an interior of second filter media of the second stage.

7. The drop-in filter element assembly according to claim 6 wherein the first stage includes a solid tube spaced from the first filter media forming an annular space receiving the partially treated fluid in the first stage.

8. The drop-in filter element assembly according to claim 1 wherein the axial staged treatment is configured for outside-in flow in the first stage and inside-out flow in the second stage.

9. The drop-in filter element assembly according to claim 8 in which the intermediate endcap unit is configured to direct fluid from the interior of first filter media of the first stage to an interior of second filter media of the second stage.

10. The drop-in filter element assembly according to claim 8 wherein the intermediate endcap unit seals against a filter housing to isolate pre-treated fluid from post-treated fluid.

11. The drop-in filter element assembly according to claim 1 wherein the axial staged treatment is configured for inside-out flow in the first stage and outside-in flow in the second stage.

12. The drop-in filter element assembly according to claim 1 wherein the first and second stages are modular.

13. The drop-in filter element assembly according to claim 12 wherein the intermediate endcap unit is formed of two endcaps coupled together to provide the modular construction.

14. A drop-in filter element assembly with axial staged treatment comprising:
a proximal endcap configured to be positioned within a filter housing adjacent the inlet flow through the filter element including a central opening;
a first filter media extending from the proximal endcap and configured to treat the fluid flowing therethrough in a first stage in an in-side out flow direction;
an intermediate endcap unit coupled to the first filter media and spaced from the proximal endcap;
a second filter media extending from the intermediate endcap unit and configured to treat the fluid flowing therethrough in a second stage, wherein the second filter media is a distinct type of media from the first filter media; and
a distal endcap configured to be positioned within the filter housing adjacent the outlet flow through the filter element and coupled to the second filter media and spaced from the intermediate endcap unit, wherein the first and second filter media provide axially staged treatment to the fluid.

15. The drop-in filter element assembly according to claim 14 wherein the axial staged treatment is configured for inside-out flow in the first stage and outside-in flow in the second stage.

16. The drop-in filter element assembly according to claim 15 wherein the first stage includes a solid tube spaced from the first filter media forming an annular space receiving the partially treated fluid in the first stage.

17. The drop-in filter element assembly according to claim 14 wherein the axial staged treatment is configured for inside-out flow in the first stage and outside-in flow in the second stage.

18. A drop-in filter element assembly with axial staged treatment comprising:
a proximal endcap configured to be positioned within a filter housing adjacent the inlet flow through the filter element;
a first filter media extending from the proximal endcap and configured to treat the fluid flowing therethrough in a first stage;
an intermediate endcap unit coupled to the first filter media and spaced from the proximal endcap;
a second filter media extending from the intermediate endcap unit and configured to treat the fluid flowing therethrough in a second stage, wherein the second filter media is a distinct type of media from the first filter media and treats the fluid in an outside-in flow in the second stage; and
a distal endcap configured to be positioned within the filter housing adjacent the outlet flow through the filter element and coupled to the second filter media and spaced from the intermediate endcap unit, wherein the first and second filter media provide axially staged treatment to the fluid.

19. The drop-in filter element assembly according to claim 18 wherein the axial staged treatment is configured for outside-in flow in the first stage and outside-in flow in the second stage.

20. The drop-in filter element assembly according to claim 18 wherein the axial staged treatment is configured for inside out flow in the first stage and outside-in flow in the second stage.
